(19) United States
(12) Patent Application Publication
(10) Pub. No.: US 2019/0149322 A1
(43) Pub. Date: May 16, 2019

(54) VERIFYING IDENTITY IDENTIFIER TRANSMITTED BY AN AERIAL VEHICLE

(71) Applicant: Airspace Systems, Inc., San Leandro, CA (US)

(72) Inventors: Guy Bar-Nahum, Sausalito, CA (US); Aislan Gomide Foina, El Cerrito, CA (US)

(21) Appl. No.: 16/143,172

(22) Filed: Sep. 26, 2018

Related U.S. Application Data
(63) Continuation-in-part of application No. 15/839,661, filed on Dec. 12, 2017, now Pat. No. 10,192,451.
Application No. 15/839,661 is a continuation of application No. PCT/US2016/037071, filed on Jun. 10, 2016.
(60) Provisional application No. 62/566,450, filed on Oct. 1, 2017.
(60) Provisional application No. 62/566,450, filed on Oct. 1, 2017.
(60) Provisional application No. 62/175,153, filed on Jun. 12, 2015.

(51) Int. Cl. H04L 9/08; H04L 9/32; H04L 9/06; B64C 39/02; G06F 16/903

(52) U.S. Cl. CPC H04L 9/085; H04L 9/3213; B64C 2201/12; B64C 39/024; G06F 16/903; H04L 9/0643

(57) ABSTRACT

A wireless communication receiver is used to receive a wireless signal that identifies an identifier transmitted by an aircraft. A token value and a vehicle identifier are obtained from the received transmitted identifier. A secret corresponding to the vehicle identifier is obtained. A synchronized time value is obtained. A comparison token value is generated using the secret and the synchronized time value. The obtained token value and the generated comparison token value are compared to determine an authenticity of the received transmitted identifier.

### CROSS REFERENCE TO OTHER APPLICATIONS

This application claims priority to U.S. Provisional Patent Application No. 62/566,450 entitled ENCRYPTION FOR LOW ALTITUDE AIRCRAFT IDENTIFICATION SYSTEMS filed Oct. 1, 2017 which is incorporated herein by reference for all purposes.

This application is a continuation-in-part of co-pending U.S. patent application Ser. No. 15/839,661 entitled LOW ALTITUDE AIRCRAFT IDENTIFICATION SYSTEM filed Dec. 12, 2017, which claims priority to U.S. Provisional Patent Application No. 62/566,450 entitled ENCRYPTION FOR LOW ALTITUDE AIRCRAFT IDENTIFICATION SYSTEMS filed Oct. 1, 2017, both of which are incorporated herein by reference for all purposes. U.S. patent application Ser. No. 15/839,661 is also a continuation of and claims priority to International (PCT) Application No. PCT/US2016/037071 entitled A LOW ALTITUDE AIRCRAFT IDENTIFICATION SYSTEM filed Jun. 10, 2016, which claims priority to U.S. Provisional Patent Application No. 62/175,153 entitled LOW ALTITUDE AIRCRAFT IDENTIFICATION SYSTEM filed Jun. 12, 2015, both of which are incorporated herein by reference for all purposes.

### BACKGROUND OF THE INVENTION

Unmanned aerial vehicles (UAVs) or unmanned aircraft systems (UASs) markets once belonged to professional companies. However, related art UAVs and UASs now include amateur pilots flying affordable models available for purchase, for example, in an electronic store, and which may be controlled by mobile communication devices such as smartphones. However, these related art flying objects may cause damage and/or injury due to their altitude, speed and weight. Thus, there is a need to manage the UAVs and UASs.

In ground-based systems, such as the related art automotive market, one of the bases of the car control system may include an identification credential issued by a division of motor vehicles (DMV) or others, such as a license plate. However, there is no analogous identification method or system for related art UAVs and/or UASs. For related art small UASs (e.g., aircrafts up to 25 pounds flying up to 500 ft of the low altitude airspace), related art tail numbers that are used in commercial aircraft are too large in size (e.g., area) to be provided on these vehicles, or they will be too small to allow the small UAS identification.

An effective identification solution is needed that permits ground-level identification, as well as identification by other aircrafts of various sizes and altitudes. The identification solution also needs to be secure to prevent spoofing or misuse of the identification system.

### BRIEF DESCRIPTION OF THE DRAWINGS

Various embodiments of the invention are disclosed in the following detailed description and the accompanying drawings.

FIG. 1 shows the external view of the identification box with 4 light arrays, according to an example implementation.

FIG. 2 shows the schematic view of the identification box, according to the example implementation.

FIGS. 3A and 3B show the external view of the ground identification device facing forward and backward, according to the example implementation.

FIG. 4 shows the schematic view of the ground identification device, according to the example implementation.

FIG. 5 shows the user interface of the ground identification device, according to the example implementation.

FIG. 6 shows the server process flow, according to the example implementation.

FIG. 7 shows the identification box software flow, according to the example implementation.

FIG. 8 shows the remote (e.g., ground) device software flow, according to the example implementation.

FIG. 9 is a block diagram illustrating an embodiment of a system for vehicle identifier authentication.

FIG. 10 is a flowchart illustrating an embodiment of a process for generating an authenticatable identifier to be broadcasted.

FIG. 11 is a flowchart illustrating an embodiment of a process for verifying an authenticity of a transmitted authenticatable identifier.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In some embodiments, a low altitude aircraft identification system includes three components: a small aircraft electronic identification box with an embedded logger, ground identification equipment to automatically identify the aircraft pointing at it, and a central identification code database server.

The identification code can be transmitted by a visible light color sequence or by a radio frequency signal. The ground identification device is capable of recognizing both kinds of code.

A traffic management system has the function of monitoring the traffic and the ability of notifying the responsible party in case of any non-compliance with a regulation. Therefore, an operation to identify the responsible party is to identify the vehicle. The ground traffic management system requires all vehicles to have a license plate for driving on public roads. This license plate allows the police and other drivers to identify the vehicle.

With respect to UAVs and UASs, there is a need to have a structure that permits identification, as with a traffic management system.

Instead of stamping letters and numbers in the aircraft, the present example implementation is directed to a light array that blinks a defined color pattern sequence for each aircraft. One potential advantage of this identification mechanism is the possibility for a person to visually identify an aircraft from a distance of about 500 feet, without the use of any special equipment. The color sequence, blinking speed, and the meaning thereof can be defined by the pilot, the fleet control, or even by a regulatory agency. The number of colors used and the number of blinks may define the quantity of codes possible.

In some embodiments, together with the light array, the electronic identification box has a position logger and a transponder. The position logger has a global positioning system (GPS) module to obtain the absolute position where the aircraft is flying by. The logger stores the flight path of each trip made by the aircraft. Together with the positioning information, the speed and heading may also be stored. Telemetry data provided by the aircraft sensors, such as inertial measurement unit (IMU) and power level, and application data provided by the autopilot or any embedded component are also stored. This information is the proof of the aircraft real flight data, and it may perform functions similar to a civil aviation “black box” in case of a crash. In addition, in case of a UAV doing an autonomous flight beyond line-of-sight, the data may show where the UAS flew by.

The transponder may transmit a code similar to the one generated (e.g., blinked) by the light arrays but through the RF frequency, allowing automatic identification by any RF receiver on land, or installed in other aircrafts. For example, a Service Set Identifier (i.e., SSID) is broadcasted. The SSID may conform to the IEEE 802.11 wireless standard and the SSID may be utilized to identify the aircraft and also can be used to establish a wireless communication with the aircraft. In some embodiments, the SSID includes a unique identifier of the aircraft as well as a token that can be used by the receiver to verify that the SSID is a valid SSID of the aircraft. To increase security of the SSID and prevent another aircraft from replaying the SSID, the token included in the SSID may dynamically change over time, resulting in an SSID that when replayed at a later time is no longer valid. In addition to the code, the transponder may also transmit the last position, including but not limited to heading and speed, thus allowing the implementation of a collision avoidance system. The identification box has also an independent battery to allow the transmitter to work even without the external power supply. Accordingly, in case of an aircraft crash, the transponder will continue to transmit the last known position so that the wrecked vehicle may be located or identified.

The identification box has a photo sensor configured to receive external signals. In case the photo sensor is excited with a high luminous beam at a specific wavelength and modulation, such as a laser beam, the identification box may change its operational behavior. The identification box can, for instance, change its light brightness, send commands to the autopilot, and increase the data storage frequency, but is not limited thereto.

One of the preset configurations for the photo sensor stimulation is to modify flag data in the RF data sent by the transmitter, and/or the behavior of the blinking pattern. In some scenarios, multiple aircraft may be flying close to each other, in a way that a receiver on the ground is detecting all of the flying aircraft without knowing which UAV is transmitting each identification code. Therefore, it is just a matter of directing a specific wavelength and modulated light beam emitter to one of the aircrafts, and the aircraft will thus modify its behavior and its transmitted data, allowing the data-to-vehicle association. This feature creates a duplex communication, allowing the identification box to send broadcast data by its color light emitters, and receive directional data through the light sensor.

Commands can also be received and executed using the communication channel. Through a physical connection between the identification box and the UAV autopilot, the identification box can, for instance, receive a way point change command through a modulated light beam and change the UAV destination coordinates.

A police department may maintain law enforcement agents who are supervising the roads and highways in order to detect drivers disobeying traffic laws. Devices such as radar allow police officers to detect the vehicle speed. Moreover, the license plate allows for identifying the vehicle owner and accessing the complete history of the vehicle. This kind of control allows for small remote controlled aircraft surveillance and regulation.

The example implementation includes a remote (e.g., ground) device to assist in the aircraft identification. Since the electronic identification box relies on visual information, the ground device is equipped with a camera, lens, and image processing algorithms to capture the color sequence. In addition, this device has an RF receiver capable of receiving the identification box RF signal to connect both information sources and to verify the authenticity. The device may also have a network connection through Wi-Fi or the cellphone network to access the identification server.

The aircraft code and the position where the aircraft was detected are submitted to the central identification server to identify its owner, the responsible pilot, and the flight permission. Hence, if the remote (e.g., ground) user wants to check if one specific vehicle has the flight permission to fly in that area, that user directs the identification device in the vicinity of the aircraft. The identification device automatically handles the identification and crosschecks with the identification database. After the database server verifies the information, the device shows on the screen if the aircraft position and timestamp are according to its permitted flight plan. In one example implementation, the device screen shows a “valid” message. Otherwise, the user will see an “invalid” message. Clicking on the message is possible to see all the information database information associated with the aircraft.

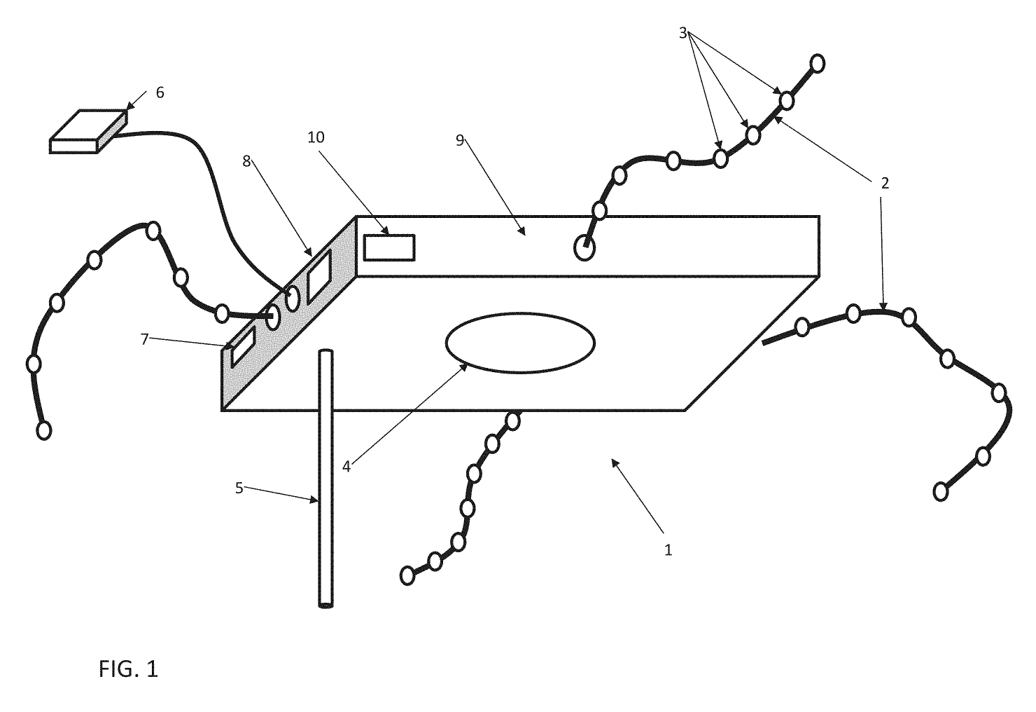

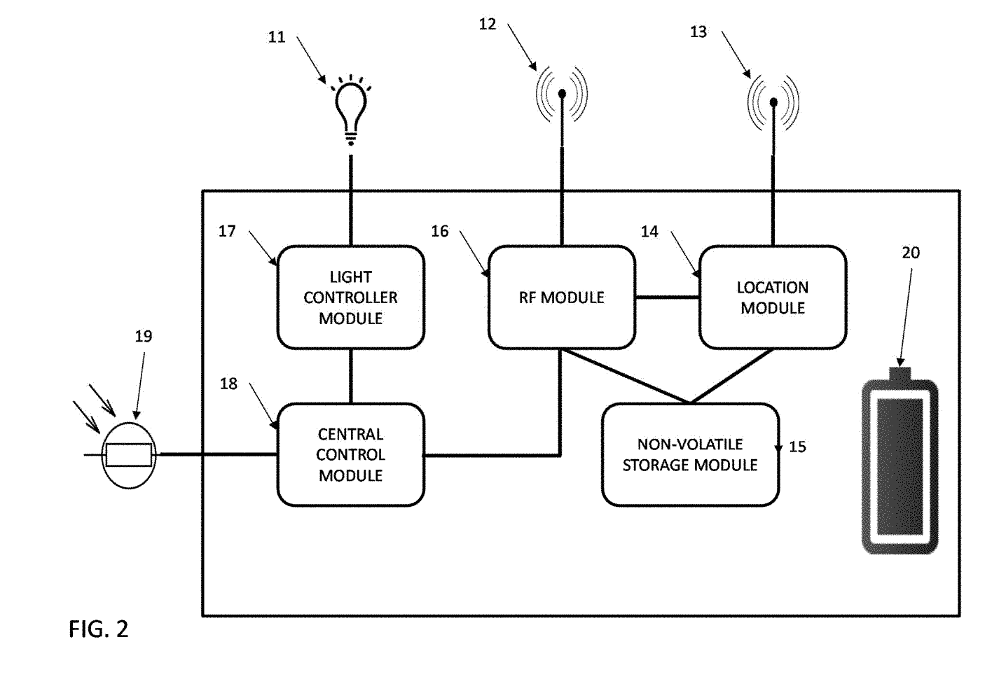

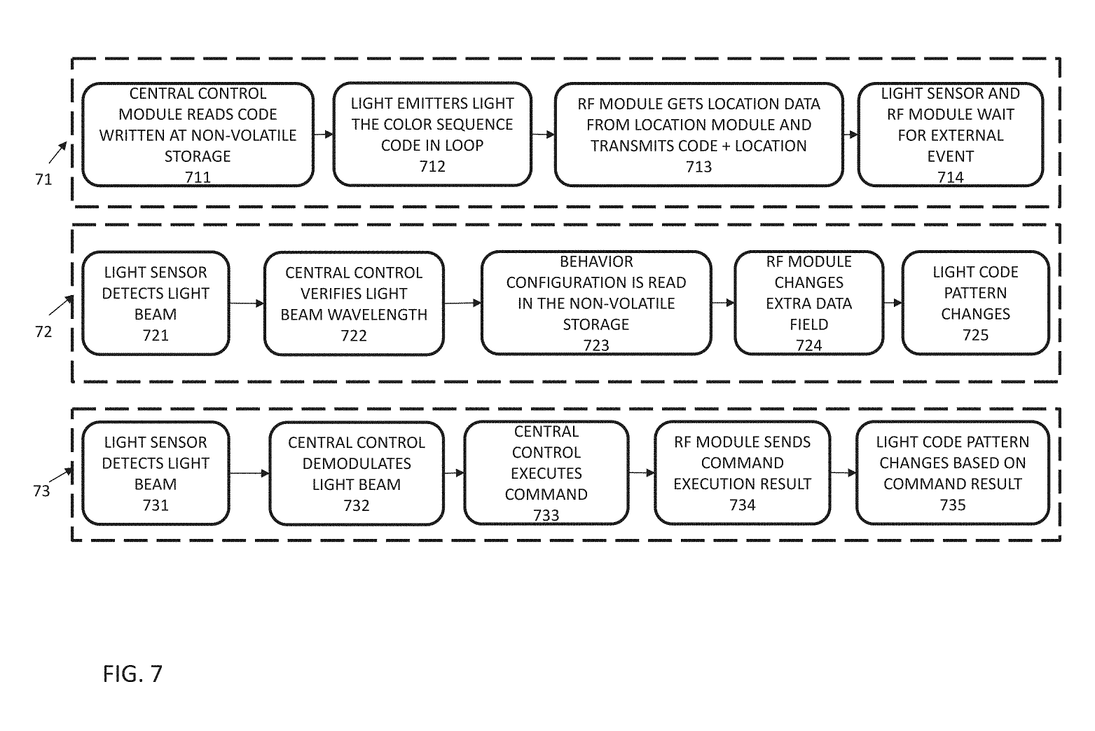

FIG. 1 shows the perspective view of one of the two components of the example implementation, FIG. 2 shows its schematic with the internal components, and FIG. 7 shows an example firmware execution flow.

As shown in FIG. 1, the identification box 1 includes one or more light arrays 2 each including several light color emitters 3. These color emitters 3 are controlled by the light controller module 17 as shown in FIG. 2 as being connected to color emitters 11. More specifically, the color emitters 3 generate (e.g., blink, variable light intensity or color fade) a defined color sequence programmed in the unit firmware executed by the central control unit 18 (shown in FIG. 2), and following the main loop flow 71, shown in FIG. 7 and described below.

The identification box 1 also has a radio antenna 5 connected to an RF module 16 shown in FIG. 2 as being connected to RF antenna 12, that transmits the same code or a modified version of the code through a radio signal. For example, RF antenna 12 is used to broadcast an SSID. The SSID may conform to the IEEE 802.11 wireless standard and the SSID may be utilized to identify the aircraft and also can be used to establish a wireless communication with the aircraft. In some embodiments, the SSID includes a unique identifier of the aircraft as well as a token that can be used by the receiver to verify that the SSID is a valid SSID of the aircraft. To increase security of the SSID and prevent another aircraft from replaying the SSID, the token included in the SSID may dynamically change over time, resulting in an SSID that when replayed at a later time is no longer valid. The RF module 16 can receive the RF signal from identification boxes (e.g., nearby) installed in other aircrafts, and save this information in the non-volatile storage module 15 that is connected to the memory card installed in the memory card slot 7.

The example implementation also has one light detection sensor 4 connected to a light receiver module 19 configured to detect external excitation by a light beam with defined wavelength and intensity. In the case of external light detection by the light sensor 4, the light beam detection flow 72 of FIG. 7 is executed. Consequently, the behavior of the identification box 1 can change, for instance, adding or changing extra data information to the transmitted RF signal or changing the light blink pattern or intensity.

Additionally, the identification box 1 also has a location system antenna 6 (e.g., GPS antenna) connected to a location module 14, shown in FIG. 2 as being connected to system antenna 13, to log the flight path in the storage module 15. This positioning data (e.g., GPS data, camera motion capture, radio triangulation system) is also transmitted by the RF module 16 together with the identification code.

The identification box 1 has also an external power connector 8 used to recharge the internal power storage 20 (e.g., LiPo (Lithium-Polymer) battery or super capacitor) and supply power to all internal and external components.

In case of no power being supplied, the internal power storage 20 can supply power to all the components. In this “no external power” state, the RF module 16 may keep following the main loop flow 71, and transmit the last location position and the identification code until the battery runs out of power, while the other components will be in a sleep mode.

All the internal components are protected by a housing 9 (e.g., standard weatherproof box) against impact and weather, in order to resist a crash without damaging the internal circuit.

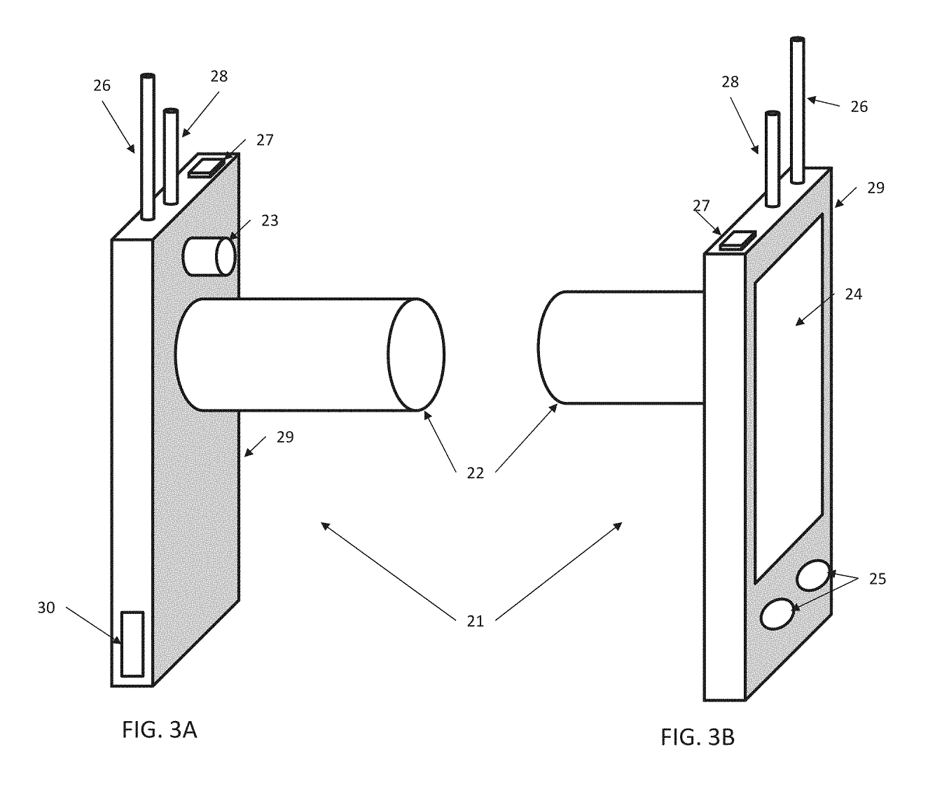

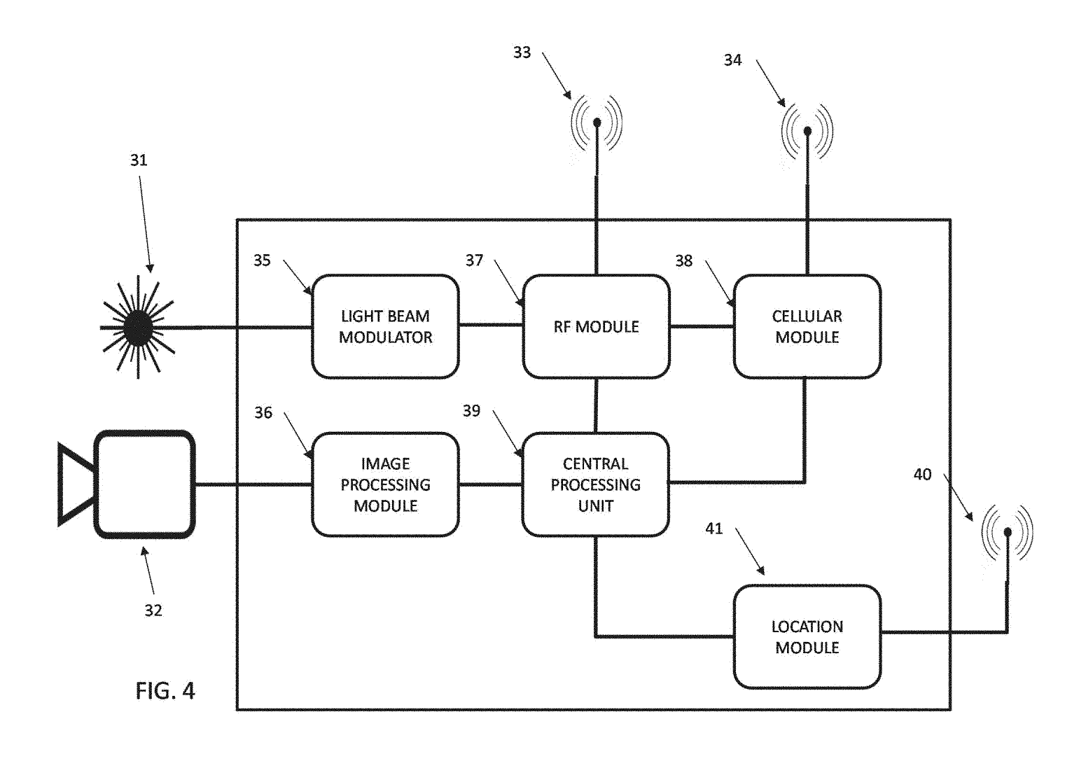

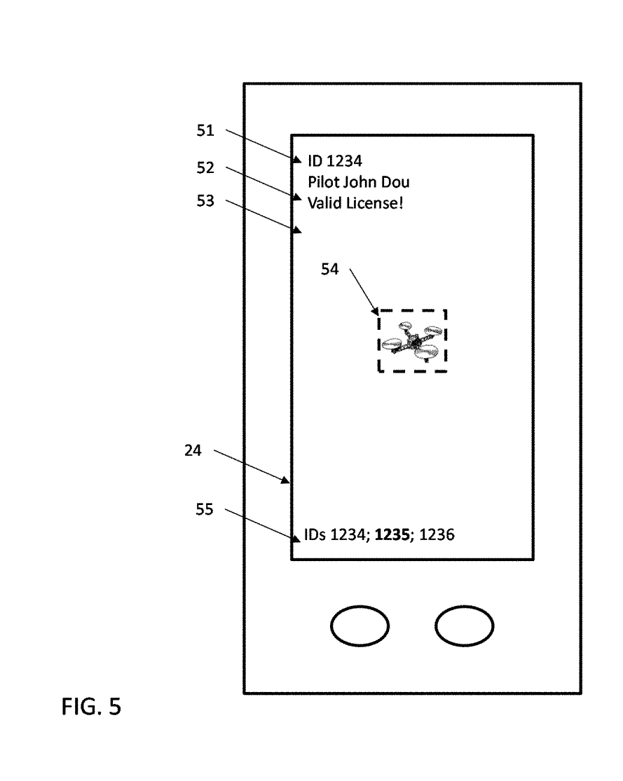

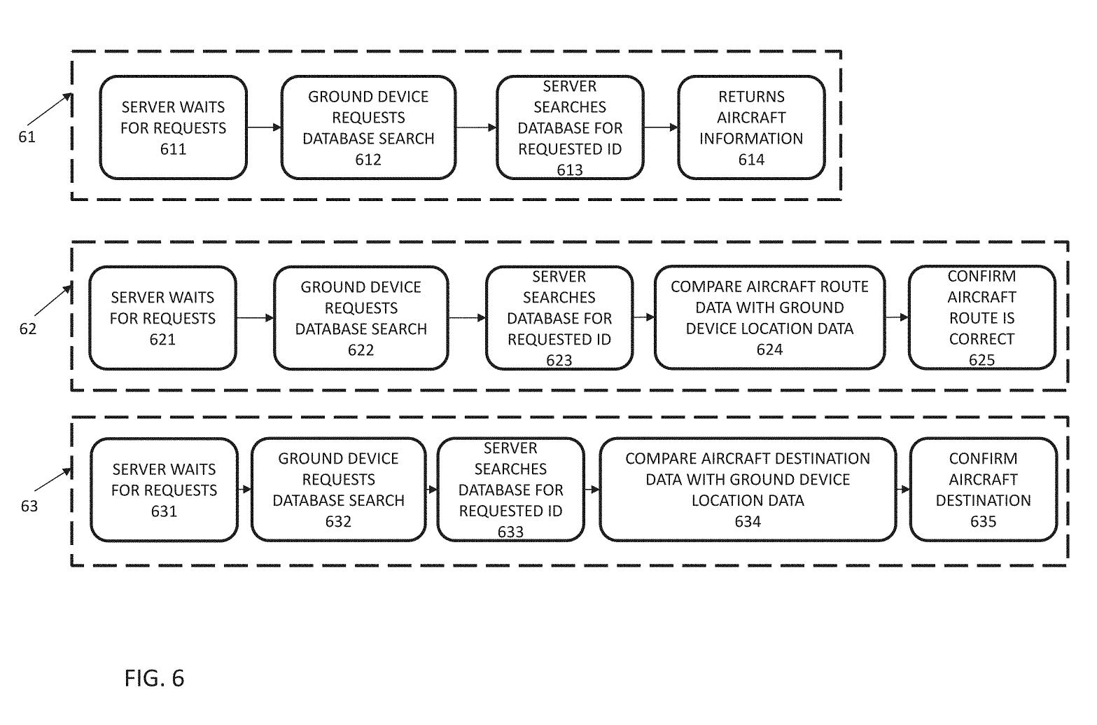

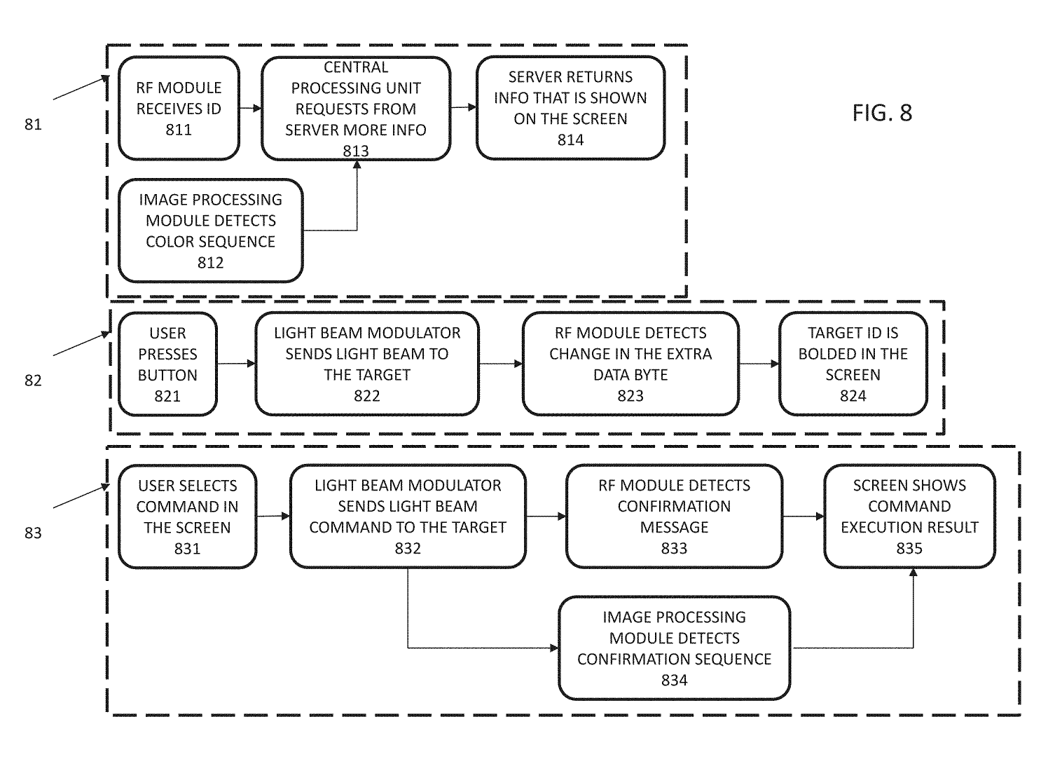

The other component of the example implementation is the ground identification device 21, which is remote from the UAV or UAS, as shown in a left and right perspective in FIGS. 3A and 3B respectively, and with its internal schematic in FIG. 4. In addition, the main user interface is shown in FIG. 5, the server process in FIG. 6, and its firmware process flow in FIG. 8. The ground identification device 21 may be a custom-made device, specifically for the example implementation. Alternatively, the ground identification device 21 may be a mobile communication device (e.g., smartphone), containing instructions (e.g., software or downloadable and/or online application) as would be known to those skilled in the art. The mobile communication device can also be attached to external components like a zoom lens or light beams, but not limited to, to be able to execute other features of the ground device 21.

The ground identification device 21 has a camera with zoom 22 capable of capturing images such as video in real-time. The identification procedure flow 81 as shown in FIG. 8 is executed to process the video and identify the aircraft. This video goes to an image processing module 36, connected to camera 32 in FIG. 4, which analyses the image to detect that the identification box blinks and captures the blink sequence.

In case of a successful detection, the detected code is informed to the touchscreen 24, in the field 51 as shown in FIG. 5. A detection window 54 will be shown around the detected aircraft. A request to a server will be made to obtain further aircraft data, following the aircraft request data flow 61 as shown in FIG. 6. Other information, associated with the aircraft owner and presented in the field 52, is provided.

A location system antenna 27 (e.g., GPS antenna) is connected to a location module 41 as antenna 40 in FIG. 4, in order to get the position where the aircraft was detected. Both information, including the detected ID and the location detection position, are transmitted to a server through a data communication antenna 28 connected to a cellular data communication module 38 as antenna 34 in FIG. 4 (e.g., cellular network or Wi-Fi). The server will follow the aircraft route confirmation process 62 as shown in FIG. 6, and reply an ID verification message that is presented in the field 53 of the touchscreen 24.

The ground identification device 21 also can detect aircrafts through the RF signal transmitted from the identification box RF module 16. The signal is received by the RF receiver antenna 26 connected to the RF receiver module 37, shown as antenna 33 in FIG. 4. Since many signals can be received at the substantially same time by the receiver module 37, the detected IDs are presented in the field 55 in a list format. If at any time the user decides to use the touchscreen 24 to select (e.g., click) on any ID number, a request will be made to a server following the aircraft information flow 61 of FIG. 6, to show more information about that aircraft.

In order to activate (e.g., excite) the identification box light sensor 19, the ground device has a light beam emitter 23 connected to a light beam modulator 35, shown as emitter 31 in FIG. 4. The light beam excitation flow 82 is executed by the ground device 21. This beam, when captured by the light sensor 19 will change the data transmitted by the identification box RF module 16. This difference in the data is detected by the ground device RF module 37, and the light excited aircraft ID presented in the field 55 will be shown in a distinguishable form, for example but not by way of limitation, bold-text.

The ground device internal components are protected by a weather proof housing 29. The front screen panel has few general-purpose buttons 25 that can be configured, for instance, to perform commands provided by the user, such as to activate the light beam.

The identification box light emitters 3 and light sensor 4 of the identification box 1 create a two-way communication system. Similarly, the ground device camera 22 and light beam emitter 23 of the ground device 21 also create a two-way communication system. The RF module 16 that can be included in identification box 1 and RF module 37 that can be included in ground device 21 can be used to establish a duplex communication between identification box 1 and ground device 21. Therefore, the identification box 1 and ground device 21 together can exchange information through light or RF. This feature allows other applications. One example application may be to send data to a UAV through light and RF.

For instance, a delivery drone can receive a message to update its destination coordinate when the delivery drone gets closer to the delivery address as described following. The ground device 21 detects the UAV flying at a long distance from the user address through the RF signal received by the RF module 37. The ground device 21 communicates with the server sending the received ID and the device location capture by the location module 41 (e.g., GPS, AGPS, Wi-Fi mapping, or cellphone tower position) to check if the received ID belongs to a delivery UAV going to the ground device position.

The server follows the aircraft destination process flow 63 shown in FIG. 6 to return the confirmation to the ground device 21. When the server confirms if the UAV is going to the ground device position, the ground device 21 shows on its screen 24 a message informing the user that his delivery is arriving. The user points the ground device 21 to the UAV (e.g., goes outdoors), and uses one of the general-propose buttons 25 to turn on the light emitter 23.

At this moment, the ground device 21 will start to transmit its position through the RF module 37. The light sensor 4 of the identification box 1 detects the light beam and the RF module 16 receives the ground device 21 position. The identification box central control module 18 sends a destination update to the UAV autopilot through the autopilot connector 10. After that, the UAV will update its destination to drop the delivery in the exact location the user is transmitting.

In addition, other applications can be provided if the ground device 21 is attached to an aircraft, and the identification box 1 is attached to a ground object. For instance, an automated landing procedure in a mobile landing pad attached to a vehicle can use these devices in this configuration. The identification device 1 is attached to several landing pads, each one sending a unique identification code through the light emitters/arrays 2 and the RF module 16 simultaneously.

The aircraft with the ground device 21 pointing to the ground receives the landing pad ID and the location data through the RF module 37. A connection between the aircraft autopilot and the ground device 21 through the data connector 30 allows the ground device to send messages to the aircraft, a destination coordinates update for instance. After receiving the landing pad ID, the ground device 21 searches for the landing pad visual position of that specific landing pad color sequence using the camera 22.

This process allows a fine control of the aircraft using real-time optical navigation to approach and land in the moving landing pad. This application can be executed in an outdoor and indoor environment, even without the location data being transmitted by the landing pad identification box.

Further, the ground device 21 can modulate data through the light beam modulator 35. The identification box central control module 18 can demodulate the light beam in order to execute commands. The light beam command transmit flow 83 shown in FIG. 8 is executed by the ground device 21. The user selects the command on the screen 24, and the light beam modulator 35 turns the light beam emitter 23 on and off in a defined frequency and protocol. The identification box light sensor 4 detects the modulated light beam and sends the binary data to the central control unit 18 that is executing the light beam command execution flow 73 shown in FIG. 7.

After the command execution, the identification box 1 sends the execution results (e.g., an ACK or an error status code) to the ground identification unit 21 through the RF module 16 and it can also change the color sequence to show the result visually. For instance, the light controller module 17 can turn the red color on for a while in case of an invalid command, and the green light on in case of a successfully executed command.

In FIG. 4, the central processing unit 39 receives inputs from the location module 41, the cellular modem 38, the RF module 37, the light beam modulator 35, and the image processing module 36, and performs the processes (e.g., software or instructions) associated with the ground identification unit 21.

FIG. 6 shows a server process flow, according to the example implementation. As explained above, and as shown in the flow 61, a server may await the receipt of a request at 611, such as from a ground device, for example. At 612, a ground device may request a database search, as explained above. At 613, the server receives the request from the ground device, and performs a search on the database for the requested identity information, which was based on the combination of light signals, blanks, etc. as explained above. At 614, upon obtaining the requested identification information of the aircraft, the requested information is returned to the ground device. Accordingly, the ground device may obtain identification information of the small and/or low altitude aircraft.

According to another example implementation of the server process flow, as shown in flow 62, at 621, the server waits for one or more requests from the ground device. At 622, the ground device provides a request for a database search. At 623, and as explained above, the server receives the request, and performs a search of the database for the requested identifying information of the aircraft. At 624, the server performs a comparison of the aircraft route data with the ground device location data. In this operation, the server confirms whether the aircraft is on the correct route or not. At 625, the server provides a confirmation to the ground device as to whether or not the aircraft route is correct. At this point, a ground device or the server may optionally perform an action, such as providing a report of an incorrect aircraft route, or other report that one skilled in the art would understand to provide if an aircraft is not on a correct route.

According to yet another example implementation of the server process flow, as shown in flow 63, a server may await the receipt of a request at 631. As explained above, a ground device may provide a request for a database search to the server at 632. At 633, and as explained above, upon receiving the request from the ground device for a server search, the server performs the search for the requested ID, and determines the identification of the aircraft. At 634, the server performs a comparison between the aircraft destination data and the ground device location data. At this point, the server confirms whether the aircraft is at the correct destination or not. At 635, the server provides a confirmation to the ground device as to whether or not the aircraft is at the correct destination. At this point, and as explained above with respect to operation 625, the ground device or the server may optionally perform an action indicative of the correctness of the aircraft destination.

FIG. 7 shows the identification box software flow, according to the example implementation. For example, but not by way of limitation, the flows 71, 72, 73 may be implemented on a processor that is present in the identification box as explained above. Alternatively, various operations may be offloaded to other processors in the identification box.

As shown in flow 71, and as explained above, at 711, the central control module reads instructions stored in a non-volatile storage. Based on the reading of those instructions, at 712, the central control module instructs light emitters to light a color sequence instruction in a loop. The color sequence instruction may be determined based on the command received at the central control module. At 713, the RF module receives location data from a location module, and transmits a code and location information associated with the location data. The RF module performs this operation in response to a command from the central control module. The central control module may provide this command based on the code or instructions stored in the nonvolatile storage. At 714, the light emitters are emitting the instructed color sequence, and the RF module has obtained the necessary location data and prepared the necessary information, and the identification box, including the light sensor and RF module, is waiting an external event, such as the heat of information from the ground device.

As shown in flow 72, and is also explained above, at 721, a light sensor detects a light beam. For example, the light beam may be received from the ground device. At 722, the central control module receives the light beam information, and verifies the wavelength of the light beam. Based on the wavelength of the light beam, it is determined whether the received light beam is a light beam associated with an instruction for that aircraft associated with the identification box that is attached to the aircraft. At 723, a behavior configuration is read from the nonvolatile storage by the central control module. At 724, the RF module changes an extra data field based on the information provided in operation. At 725, a light coat pattern is changed based on the instruction also provided from the central control module, based on the information received in operations 721, 722, and 723. Accordingly, an instruction is provided, either by the ground device, another aircraft, or a flight control tower, or other source of instruction as would be understood by those skilled in the art, to instruct the identification box of the aircraft to change the light code pattern. The light code pattern change may be indicative of a certain status of the aircraft, such as being on the correct or incorrect destination, or other information.

As shown in flow 73, the light sensor of the identification box may detect the light beam at 731. At 732, the central control module may demodulate the light beam, thus determining any information instruction associated with the light beam. At 733, the central control may execute a command based on the information and instructions received in the demodulated light beam. At 734, the RF module may send a command execution result from the screen of the user interface of the ground device. At 735, the light code pattern may change based on the command execution result.

FIG. 8 shows the remote (e.g., ground) device software flow, according to the example implementation. As shown in flow 81, at 811, the RF module of the ground device may receive identification information, such as the identification information of the aircraft. At 812, the image processing module may detect a color sequence associated with the aircraft that is admitted by the identification box. At 813, the central processing unit of the ground device may transmit a request to the server to obtain information associated with the color sequence that was received. At this point, one or more of the operations described above in flows 61, 62 and/or 63 may be performed. At 814, the server returns the requested information to the ground device, and the requested information is shown on the screen, as explained above.

As shown in flow 82, at 821, a user may activate an object on a user interface, such as pressing a button on a screen of the ground device. At 822, a light beam modulator may transmit a light beam from the ground device to a target. For example, but not by way of limitation, the target may include the aircraft, and more specifically, the identification box of the aircraft. At 823, the RF module may detect a change in the extra data byte, as explained above. Further, at 824, the target ID may be bolded or otherwise identified in the user interface, so as to highlight to the user the change in that target ID associated with the aircraft.

As shown in flow 83, at 831, the user may select a command in the screen. At 832, a light beam modulator may send a light beam command to the target, such as the identification box of the aircraft as explained above. At 833, the RF module may detect a confirmation message received from the target, such as a message received from the identification box. Further, in response to the light beam, at 834, the image processing module may also detect a confirmation sequence, as shown above. At 835, the screen receives and shows a result of the command execution, as also explained above.

The related art aircraft identification systems focus on civil or military aviation. None of the related art systems work for a small aircraft in a low altitude. Using a visible light sequence, an aircraft in a low altitude flight may be visually identified. The other related art identification systems for aircraft need a radar system or special devices to be able to receive the identification signal, which works well for a scenario involving an airport tower and an aircraft, but does not work for a scenario involving a person without such devices and an aircraft. Using visible light identification, a person can observe an aircraft and memorize its color sequence. This approach is similar to the way cars are identifiable by their license plate, instead of the way aircrafts are identified in the related art. Although embodiments and examples of visible light identification have been discussed herein along with the identification via RF, in some embodiments, an aircraft only implements the RF identification transmission without the visible light identification. In various embodiments, the RF identification transmission and/or the visible light identification may be used independently from each other and/or in combination. The identification system may be used to identify any vehicle, ship, aircraft, or other static or mobile objects that are located up to about 1 mile from a person.

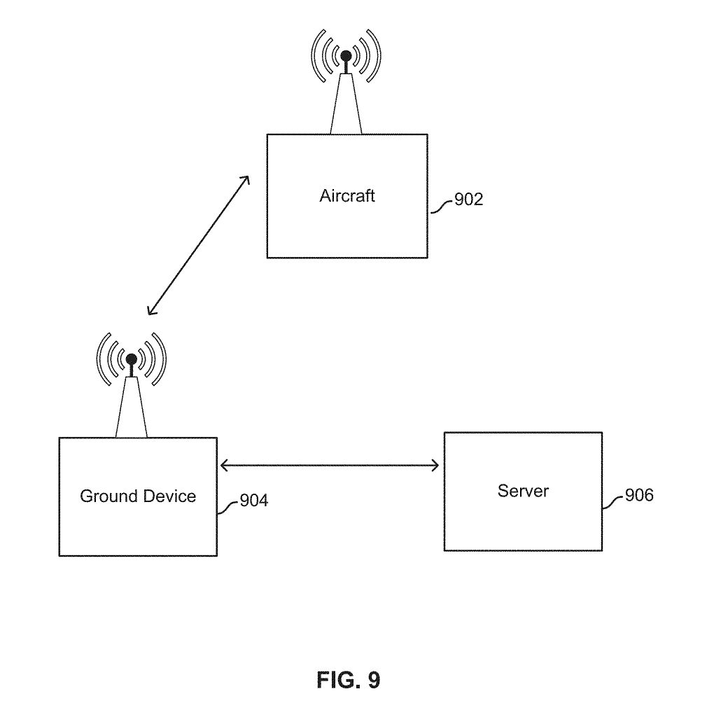

FIG. 9 is a block diagram illustrating an embodiment of a system for vehicle identifier authentication.

Aircraft 902 (e.g., drone, UAV, helicopter, airplane, multirotor, or another type of aerial vehicle) broadcasts an identifier via a wireless signal that is received by ground device 904. An example of the identifier is an SSID or any other transmitted identifier. This identifier may be utilized to verify the identity of the aircraft and its flight privileges and limitations within a certain airspace. In order to verify that the identifier of the aircraft is valid, ground device 904 authenticates the identifier using information obtained (e.g., via a wired or wireless network) for aircraft 902 from server 906. For example, ground device 904 obtains owner information, flight permissions, and a key that can be used to verify the broadcasted identifier of the aircraft. In some embodiments, aircraft 902 includes one or more components of identification box 1 of FIG. 1 and/or one or more components of the identification box shown in FIG. 2. An example of ground device 904 is ground identification device 21 shown in FIGS. 3A and 3B and/or the ground identification device shown in FIG. 4. Examples of server 906 include the servers previously discussed in the specification.

In some embodiments, there is a need for a two-way trust between the ground device/server and the aircraft. For example, but not by way of limitation, the aircraft must be able to trust that the server that is transmitting policy information from a remote location such as at ground level is authentic, and is providing verified policy information. Conversely, the server and/or the ground device must have trust that the target aircraft that is receiving the policy information is credentialed. If two-way trust is not verified, the risk of transmission and reception is high.

The risks of misidentification or erroneous validation by either the aircraft or the ground transmitter and server, or both are substantial. For example, but not by way of limitation, an aircraft that accepts an unverified policy command could be receiving that information, which may result in the aircraft performing unauthorized commands, or commands provided by bad actors. Similarly, if a transmitter from the ground is unable to verify that the drone is credentialed, the transmitter from the ground may be providing policy or command information to an un-trusted party, or a bad actor that may use this information to avoid detection, or perform bad acts.

Moreover, the forgoing example implementations permit credentialing of the aircraft so as to provide grant privileges at two levels. At the group level, a drone may be identified as being associated with a trustworthy source (e.g., company, law enforcement, etc.). At an individual level, the drone may be verified as to his individual identification based on the information transmitted to the ground device, as explained in the forgoing example implementations.

In view of the relatively short distances between a small drone and the ground identification device, as well as the relatively short time that is available for the drone to implement the policy or commands provided by the ground identification device, an ad hoc authorization network connection is required to exchange information. This connection is essentially a peer to peer connection, as opposed to a connection provided via a mobile telecommunications network or via a website or general Internet communication. The network connection is specific to the drone associated with the identifying information, and the example implementation must be able to perform the connection and communication without connectivity to the Internet, as well as without needing to clear the communication via a database for security reasons. Given the short distance of peers from each other, communication is generally limited to direct communication by RF and light signals, as explained above. Further, in view of the nature of the motion of a drone, and the speeds of movements and pursuit, the communication must be real time, and delayed or asynchronous communication may result in the drone not being able to achieve its intended task, goal, or purpose.

Depending on the carrier or protocol, the communication may be performed by RF, Wi-Fi, Bluetooth, or other communication protocol for which real-time peer-to-peer communication may be performed in a secure manner. For example, but not by way of limitation, in a Wi-Fi network, TCP/IP or HTTP/HTTPS as would be understood by those skilled in the art may be used to implement a security protocol. Similar schemes may be employed for Bluetooth communications, as explained in further detail below.

Disclosed herein are systems and processes to provide secured wireless communication utilizing SSIDs conforming to the 802.11 standard as the mechanism of network packet identification. The system implements a rotating SSID which is utilized to address information packets over wireless networks. By frequently changing the SSID, the probability of it being discovered and exploited or spoofed is greatly reduced.

In order for this system to be reliable, the transmission of the identification is reliable and unique, but also predictable to known parties so that the identification can be tracked on the server-side to ensure that the wireless beacon was not changed or cloned, etc. The system utilizes a generation technique to periodically generate a token utilized for the temporary SSID.

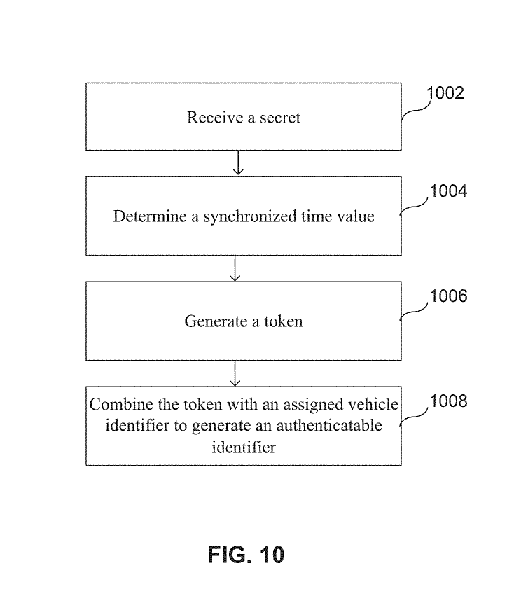

FIG. 10 is a flowchart illustrating an embodiment of a process for generating an authenticatable identifier to be broadcasted. The process of FIG. 10 may be utilized by aircraft 902 of FIG. 9 to generate and update its SSID periodically. For example, the process of FIG. 10 is repeated at a periodic interval. In some embodiments, the process of FIG. 10 is utilized by a vehicle to generate an authenticatable identifier of the vehicle to be transmitted.

At 1002, a secret is received. Examples of the secret information include an encryption key, a private key, a public key, a secret value, a password, a certificate, a credential, a hash function, a seed value, etc. The secret may be preprogrammed in a component of a vehicle (e.g., aircraft), provided via a local wired connection, received from a ground device (e.g., ground device 904 of FIG. 9), or provided from a server via a network connection. The secret can be utilized to generate a token included in the authenticatable identifier that is to be broadcasted by the vehicle (e.g., aircraft).

At 1004, a synchronized time value is determined. In order to make sure the generated token will be predictably different at specific points in time, a shared value that changes predictably over time is to be utilized. For example, a system utilizes a digital time stamp at a given moment as a portion of the information used to generate the token for the authenticatable identifier (e.g., SSID). In applications where ephemeral (volatile) memory is used, non-permanent data is lost when the system is shut down or the battery voltage becomes too low. This may have the side effect of disrupting the timing as well. Because token generation for the SSID requires that the times be the same in order for SSIDs to match, it is important that time be maintained in the event of a system shutdown.

The synchronized time value may be determined using a synchronized clock of a vehicle (e.g., clock on aircraft is synchronized with clock on a receiving device), a GPS-based clock, a radio clock, an atomic clock, WWVB radio controlled clock, a real time clock, a network time-based clock, a satellite clock, a time obtained from a time server, a commonly seeded random number generator (e.g., generating a value at a preset consistent interval), etc. For example, it is possible to utilize GPS as a “point of truth” for time synchronization, although in this case the speed with which the SSID will be cycled may become inefficient. Another option is to place the device into a configuration mode every time it starts or charges. Another solution is to use an RTC (real time clock) circuit with a long backup battery. This implementation has the additional benefit of maintaining a more accurate clock by separating the time increments from the system's compute cycles as system voltage fluctuations can cause the clock speed of a system to shift which would cause the time signature used in the SSID to be incorrect.

At 1006, a token is generated using the synchronized time value and the received secret. In some embodiments, a value based on the synchronized time is combined (e.g., concatenated) with a value based on the secret (e.g., secret value), and the combined value is encrypted using a one-way encryption function. Examples of the one-way function include a hash function, a secret key encryption, asymmetric encryption (e.g., public key cryptography), etc. In some embodiments, a value based on the synchronized time value is encrypted using the secret received in 1002. For example, at least the synchronized time value is encrypted using a hash function or an encryption key received in 1002. In some embodiments, at least the synchronized time value is encrypted using symmetric encryption. By including an encrypted value in the token, a hacker attempting to spoof the token is unable to learn the pattern of token generation to accurately generate the next token.

At 1008, the token is combined with an assigned vehicle identifier to generate an authenticatable identifier. For example, the assigned vehicle identifier is a unique identifier that has been assigned to the corresponding vehicle. Examples of the assigned vehicle identifier include a serial number, a government issued identifier, a license number, a device identifier, and any other identifier that has been assigned to uniquely identify a vehicle/aircraft and/or a hardware component of the vehicle/aircraft. Combining the token with the assigned vehicle identifier may include concatenating them together to generate a combined value that becomes the authenticatable identifier to be transmitted. The authenticatable identifier is to be used in transmitting an identity of an associated aircraft. In some embodiments, the authenticatable identifier is utilized as an SSID of a wireless network advertised by the aircraft. For example, the SSID serves as both an authenticatable unique identifier of the aircraft and a name of a wireless network advertised by the aircraft that can be used to establish a wireless network connect with the aircraft.

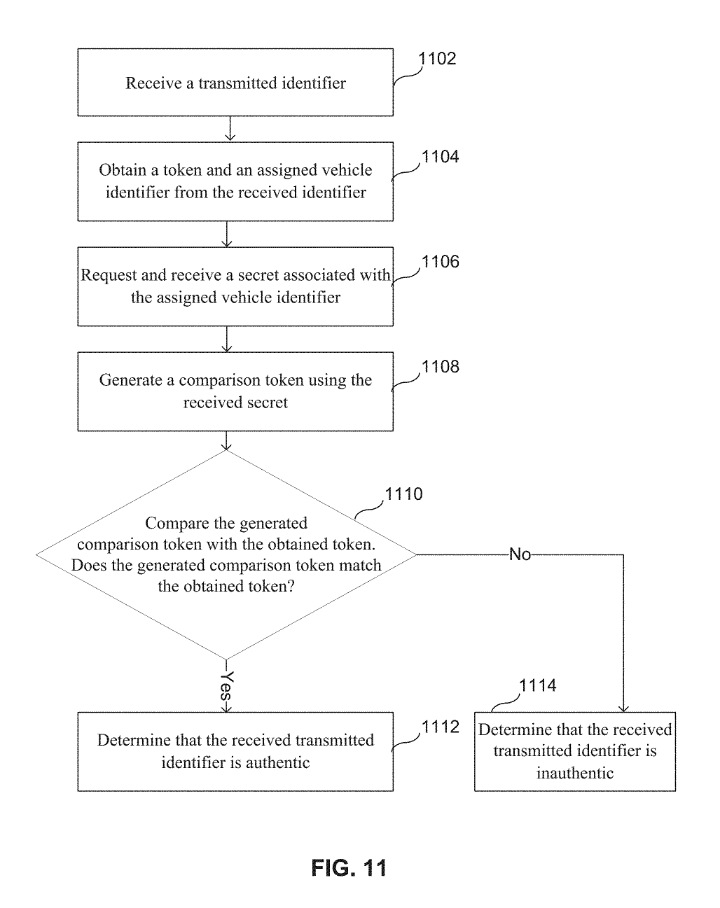

FIG. 11 is a flowchart illustrating an embodiment of a process for verifying an authenticity of a transmitted authenticatable identifier. The process of FIG. 11 may be utilized by ground device 904 of FIG. 9. For example, ground device 904 uses the process of FIG. 11 to verify an identifier received from aircraft 902 of FIG. 9.

At 1102, a transmitted identifier is received. In some embodiments, the received transmitted identifier is the authenticatable identifier generated in 1008 of FIG. 10. For example, the received identifier is an SSID of a wireless network advertised via Wi-Fi by an aerial vehicle.

At 1104, a token and an assigned vehicle identifier is obtained from the received identifier. For example, the received identifier has been formed from a combination of the token and the assigned vehicle identifier (e.g., unique identifier assigned to a vehicle that advertised the broadcasted identifier). Given a known relative ordering and fixed lengths of the token and the assigned vehicle identifier values, the token and the assigned vehicle identifier are extracted from the known locations within the received identifier.

At 1106, a secret associated with the assigned vehicle identifier is requested and received. For example, an inquiry is made to a server (e.g., server 906 of FIG. 9) using a secure communication channel to obtain the secret associated with the assigned vehicle identifier. In some embodiments, obtaining the secret in 1106 is or is based on the secret that was received in 1002 of FIG. 10. For example, a database tracks information associated with a vehicle of the assigned vehicle identifier, such as owner information, flight permissions, etc. along with the associated secret. By keeping a copy of the secret at the associated vehicle and at a trusted remote party, the vehicle is able to provide its identity to the trusted remote party using the shared secret. This database may be locally stored or stored at a remote server. A device seeking to authenticate the received transmitted identifier is then able to query this database with the assigned vehicle identifier to not only obtain the associated secret to authenticate the received transmitted identifier, but is also able to obtain other associated information of the associated vehicle, such as owner information, flight permissions, etc. Examples of the secret include an encryption key, a private key, a public key, a secret value, a password, a certificate, a credential, a hash function, a seed value, etc.

At 1108, a comparison token is generated using the received secret. For example, the similar process utilized by a vehicle to generate the token that was included in the received transmitted identifier is used to generate the comparison token. This comparison token can then be compared with the obtained token to verify that the obtained token is valid. The comparison token is generated using a synchronized time value and the received secret. The synchronized time value may be determined using a synchronized clock of the receiver (e.g., clock of ground station, server, etc.) that is synchronized with a clock on the vehicle that sent the received transmitted identifier. Examples of the synchronized clock include a GPS-based clock, a radio clock, an atomic clock, WWVB radio controlled clock, a real time clock, a network time-based clock, a satellite clock, a time obtained from a time server, etc. In some embodiments, the same clock (e.g., obtain time from common remote time service) that was utilized to generate the obtained token is used to generate the comparison token. The synchronized time value may be a time value of when the transmitted identifier was transmitted or received. In some embodiments, a value based on the synchronized time is combined (e.g., concatenated) with a value based on the received secret (e.g., secret value), and the combined value is encrypted using the one-way encryption function. Examples of the one-way function include a hash function, a secret key encryption, asymmetric encryption (e.g., public key cryptography), etc. In some embodiments, a value based on the synchronized time value is encrypted using the secret received in 1106. For example, at least the synchronized time value is encrypted using a hash function or an encryption key received in 1106. In some embodiments, at least the synchronized time value is encrypted using symmetric encryption to generate the comparison token.

At 1110, the generated comparison token is compared with the obtained token and it is determined whether the generated comparison token matches the obtained token.

If at 1110 it is determined that the generated comparison token matches the obtained token, at 1112 it is determined that the received transmitted identifier is authentic. For example, it is determined that the vehicle that transmitted the received transmitted identifier is trusted to be assigned the assigned vehicle identifier included in the received transmitted identifier. In some embodiments, in response to this determination, a communication is established with the associated vehicle using the received broadcasted identifier in a network communication protocol (e.g., IEEE 802.11). For example, the received broadcasted identifier is an SSID that is used to establish a wireless Wi-Fi connection. In some embodiments, an associated flight permission is trusted in response to the determination in 1112.

If at 1110 it is determined that the generated comparison token does not match the obtained token, at 1114 it is determined that the received transmitted identifier is inauthentic. In some embodiments, in response, a notification and/or a report of the inauthenticity is provided. In some embodiments, in response, a patrol/interdiction aerial vehicle is deployed to monitor and/or capture the vehicle that broadcasted the inauthentic identifier. In some embodiments, the process is repeated at least one or more times to verify again that an identifier broadcasted by the vehicle is inauthentic before providing a report or performing a security measure.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a wireless communication receiver configured to receive a wireless signal that identifies an identifier transmitted by an aircraft; and
a processor configured to:
obtain a token value and a vehicle identifier from the received transmitted identifier;
obtain a secret corresponding to the vehicle identifier;
obtain a synchronized time value;
generate a comparison token value using the secret and the synchronized time value; and
compare the obtained token value and the generated comparison token value to determine an authenticity of the received transmitted identifier.

2. The system of claim 1, wherein the identifier transmitted by the aircraft is a Service Set is Identifier (SSID) identifying a name of a wireless network.

3. The system of claim 1, wherein the aircraft changes its transmitted identifier at a periodic interval using a clock associated with the synchronized time value.

4. The system of claim 1, wherein the obtaining the token value includes extracting the token value from a specified portion of the transmitted identifier.

5. The system of claim 1, wherein the obtaining the token value includes extracting the vehicle identifier from a specified portion of the transmitted identifier.

6. The system of claim 1, wherein the vehicle identifier is associated with a license number for the aircraft.

7. The system of claim 1, wherein obtaining the secret includes querying a remote server using the obtained vehicle identifier.

8. The system of claim 1, wherein the secret is an encryption key.

9. The system of claim 1, wherein the secret is a shared secret between the aircraft and a trusted device.

10. The system of claim 1, wherein the synchronized time value is obtained using a clock of the system synchronized with a clock of the aircraft.

11. The system of claim 1, wherein the synchronized time value is obtained using a clock that was used to generate the obtained token value.

12. The system of claim 1, wherein the generating the comparison token value includes encrypting at least the synchronized time value.

13. The system of claim 12, wherein encrypting at least the synchronized time value includes hashing at least the synchronized time value.

14. The system of claim 1, wherein the generating the comparison token value includes combining the synchronized time value with the secret to generate a combined value and encrypting the combined value using a one way function.

15. The system of claim 1, wherein comparing the obtained token value and the generated is comparison token value includes determining whether the obtained token value matches the generated comparison token value.

16. The system of claim 1, wherein the processor is further configured to, in response to a determination that the received transmitted identifier is authentic, establish a wireless network connection with the aircraft using the received transmitted identifier.

17. The system of claim 1, wherein the aircraft is an unmanned aerial vehicle.

18. A method, comprising:
using a wireless communication receiver to receive a wireless signal that identifies an identifier transmitted by an aircraft;
obtaining a token value and a vehicle identifier from the received transmitted identifier;
obtaining a secret corresponding to the vehicle identifier;
obtaining a synchronized time value;
generating a comparison token value using the secret and the synchronized time value; and
comparing the obtained token value and the generated comparison token value to determine an authenticity of the received transmitted identifier.

19. An aircraft system, comprising:
a processor configured to:
obtain a secret corresponding to a unique vehicle identifier for the aircraft;
obtain a synchronized time value;
generate a token value using the secret and the synchronized time value; and
combine the token value with the unique vehicle identifier to generate a combined identifier; and
a wireless communication transmitter configured to advertise the combined identifier to identify the aircraft.

20. The system of claim 19, wherein the processor is configured to:
determine that a time interval to transmit a new identifier has been reached;
obtain a new synchronized time value;
generate a new token value using the secret and the new synchronized time value; and
combine the new token value with the unique vehicle identifier to generate the new identifier to be transmitted.
